(19) United States
(12) Patent Application Publication
(10) Pub. No.: US 2026/0241823 A1
(43) Pub. Date: Aug. 20, 2026

(54) Electric Tow Vehicles With Range-Extending Trailers

(71) Applicant: Harbinger Motors Inc., Garden Grove, CA (US)

(72) Inventor: John Henry Harris, III, Anaheim, CA (US)

(21) Appl. No.: 19/542,894

(22) Filed: Feb. 18, 2026

Related U.S. Application Data
(60) Provisional application No. 63/760,326, filed on Feb. 19, 2025.

(51) Int. Cl. B60L 53/53; B60D 1/64; B60L 50/60; B60L 53/12; B60L 53/16; B60L 53/22; B60L 53/62; B60L 58/12; B60L 58/18; H01M 10/625; H01M 10/656; H01M 50/249

(52) U.S. Cl. CPC B60L 53/53; B60D 1/64; B60L 50/60; B60L 53/12; B60L 53/16; B60L 53/22; B60L 53/62; B60L 58/12; B60L 58/18; H01M 10/625; H01M 10/656; H01M 50/249; B60L 2200/28; B60L 2210/30; B60L 2210/40; B60L 2240/545; B60L 2250/26; B60L 2250/28; H01M 2220/20

(57) ABSTRACT

Described herein are range-extending trailers for towing by electric tow vehicles and electric vehicle-trailer combinations comprising such trailers. In some examples, a range-extending trailer comprises a trailer battery pack and a trailer electric power coupler, connected to the trailer battery pack and configured to form an electric power connection with the electric tow vehicle. The range-extending trailer can also comprise a trailer power controller configured to control electrical power flown to or from the trailer battery pack and through the trailer electric power coupler. Specifically, the trailer power controller can form a communication link with the electric tow vehicle (e.g., vehicle power controller) and exchange control instructions through the communication link with the tow vehicle. The instructions can provide power demands to be transferred through this communication link. In some examples, the trailer also comprises a trailer mechanical coupler configured to form a mechanical connection with the vehicle.

### CROSS-REFERENCE TO RELATED APPLICATIONS

This application claims the benefit under 35 U.S.C. § 119(e) of US Provisional Patent Application 63/760,326 (Attorney Docket No. HARBP017P3) by John Henry Harris, III, titled: “Electric Tow Vehicles with Range-Extending Trailers”, filed on 2025-02-19, which is incorporated herein by reference in its entirety for all purposes.

### FIELD OF TECHNOLOGY

This patent application relates generally to electric vehicles and electric vehicle charging systems, and more particularly to electric vehicle-trailer combinations that include range-extending trailers that electrically transfer energy to an electric tow vehicle during towing operations.

### BACKGROUND

Many modern vehicles are routinely used to tow trailers. Commonly towed trailers include dry vans for the transport of commercial goods, container trailers for the transport of shipping containers, vehicle trailers for the transport of other vehicles, recreational trailers used for camping and other recreational activities, and various combinations thereof, as well as other examples. Common tow vehicles vary widely and include almost every vehicle type, ranging from Class 1 passenger cars to Class 8 heavy trucks. For purposes of this disclosure, a combination of a tow vehicle and a trailer, being towed by the tow vehicle, can be referred to as an electric vehicle-trailer combination.

In all instances, towing a trailer with a vehicle increases the energy consumption of the tow vehicle and requires a larger energy source. For a vehicle with an internal combustion engine, increasing the fuel tank size is not an issue because of the high energy density of the fuel. However, the energy density of battery packs used on electric vehicles is a lot lower. For example, a typical gas tank on a Class 1 passenger car with an internal combustion engine can hold about 40-60 liters of gasoline and have a total weight of about 100-200 kilograms when full (depending on the construction material and auxiliary equipment). It should be noted that the weight of 1 liter of gasoline is only about 0.75 kilograms. As such, increasing the size of the gas tank generally tends to increase its energy density. This amount of fuel can propel the car for about 300-500 miles. On the other hand, to achieve the same range, a battery pack on a Class 1 passenger car with an electric engine weighs about 400-600 kilograms. It should also be noted that the battery cell weight represents a large portion of this weight. Furthermore, the battery pack is usually one of the most expensive components in an electric vehicle, while a gas tank is usually one of the least expensive components in internal combustion vehicles.

Overall, for an electric vehicle, the usable vehicle range is often limited by the weight and cost of the necessary vehicle battery pack, which prevents the manufacture or economically-priced sales of electric vehicles with extremely long ranges. As a result, the increased energy consumption caused by towing a trailer may have a severe impact on the vehicle’s range, in many cases lowering the range to the extent that the vehicle no longer has a useful range when used for towing.

### SUMMARY

Described herein are range-extending trailers for towing by electric tow vehicles and electric vehicle-trailer combinations comprising such trailers. In some examples, a range-extending trailer comprises a trailer battery pack and a trailer electric power coupler, connected to the trailer battery pack and configured to form an electric power connection with the electric tow vehicle. The range-extending trailer can also comprise a trailer power controller configured to control electrical power flown to or from the trailer battery pack and through the trailer electric power coupler. In some examples, the electrical power transferred through the trailer electric power coupler is received by a vehicle electric power coupler and is used to charge a vehicle battery pack of the electric tow vehicle. Specifically, the trailer power controller can form a communication link with the electric tow vehicle (e.g., vehicle power controller) and exchange control instructions through the communication link with the tow vehicle. In some examples, the control instructions coordinate transfer of electrical energy from the trailer battery pack into the vehicle battery pack. The instructions can provide power demands to be transferred through this communication link. In some examples, the trailer also comprises a trailer mechanical coupler configured to form a mechanical connection with the vehicle.

Clause 1. A method of operating an electric vehicle-trailer combination, the electric vehicle-trailer combination comprising an electric tow vehicle and a range-extending trailer, the method comprising: forming a mechanical coupling between the electric tow vehicle and the range-extending trailer by mechanically coupling a vehicle mechanical coupler of the electric tow vehicle with a trailer mechanical coupler of the range-extending trailer, thereby enabling transmission of mechanical towing forces between the electric tow vehicle and the range-extending trailer when the range-extending trailer is towed by the electric tow vehicle; forming an electric power coupling between the electric tow vehicle and the range-extending trailer by electrically coupling (a) a vehicle electric power coupler connected to a vehicle battery pack of the electric tow vehicle with (b) a trailer electric power coupler connected to a trailer battery pack of the range-extending trailer, thereby establishing an electrical pathway for transferring electrical power between the electric tow vehicle and the range-extending trailer; forming a communication link between a trailer power controller of the range-extending trailer and a vehicle power controller of the electric tow vehicle for exchanging control instructions through the communication link between the range-extending trailer and the electric tow vehicle; determining a power transmission requirement, using one or both of the trailer power controller or the vehicle power controller, for transferring electrical power between the electric tow vehicle and the range-extending trailer based on one or more operating parameters of the electric vehicle-trailer combination; and transferring the electrical power between the trailer electric power coupler and the vehicle electric power coupler in accordance with the power transmission requirement, under control of the trailer power controller of the range-extending trailer and the vehicle power controller of the electric tow vehicle, wherein the transferred electrical power supplements power available to the electric tow vehicle from the vehicle battery pack.

Clause 2. The method of clause 1, wherein the transferring of the electrical power occurs while the electric vehicle-trailer combination is moving.

Clause 3. The method of clause 1, wherein transferring the electrical power comprises transferring the electrical power through a trailer coupler-battery interconnect connecting the trailer battery pack with the trailer electric power coupler.

Clause 4. The method of clause 3, wherein transferring the electrical power comprises using a bidirectional trailer on-board charger to: convert direct current power flown from the trailer battery pack into alternating current power flown to the trailer electric power coupler; and convert alternating current power flown from the trailer electric power coupler into direct current power flown to the trailer battery pack.

Clause 5. The method of clause 4, wherein: the electric tow vehicle comprises a vehicle on-board charger comprising a vehicle inverter; and the method further comprises converting direct current power flown from the vehicle battery pack into alternating current power flown to the vehicle electric power coupler using the vehicle inverter.

Clause 6. The method of clause 1, wherein transferring the electrical power comprises transferring alternating current power between the electric tow vehicle and the range-extending trailer through the vehicle electric power coupler and the trailer electric power coupler.

Clause 7. The method of clause 6, wherein transferring the electrical power comprises converting direct current power flown from the trailer battery pack into alternating current power flown to the trailer electric power coupler using a trailer on-board charger comprising a trailer inverter.

Clause 8. The method of clause 7, wherein: the electric tow vehicle comprises a vehicle on-board charger coupled to the vehicle battery pack and the vehicle electric power coupler; and transferring the electrical power comprises converting alternating current power flown from the vehicle electric power coupler into direct current power flown to the vehicle battery pack using a vehicle on-board charger.

Clause 9. The method of clause 8, wherein the trailer battery pack operates at a different voltage than the vehicle battery pack.

Clause 10. The method of clause 8, wherein the trailer battery pack operates at a different state of charge than the vehicle battery pack.

Clause 11. The method of clause 8, further comprising forming a connection between the trailer on-board charger and an external AC power source using a trailer connector and charging the trailer battery pack using alternating current power from the external AC power source.

Clause 12. The method of clause 8, further comprising forming a connection between the vehicle on-board charger and an external AC power source and charging the vehicle battery pack using alternating current power from the external AC power source.

Clause 13. The method of clause 1, wherein the control instructions received at the trailer power controller from the electric tow vehicle comprise a power transfer demand from the trailer battery pack.

Clause 14. The method of clause 13, wherein determining the power transmission requirement comprises determining the power transfer demand based on one or more of: a throttle position, a brake pedal position, a state of charge of the vehicle battery pack, and a temperature of the vehicle battery pack.

Clause 15. The method of clause 1, wherein controlling the transferring of the electrical power comprises controlling the electrical power based on one or more of: the control instructions received at the trailer power controller from the electric tow vehicle, a state of charge of the trailer battery pack, and a temperature of the trailer battery pack.

Clause 16. The method of clause 1, wherein determining the power transmission requirement and transferring the electrical power comprise prioritizing cycling of the trailer battery pack over the cycling of the vehicle battery pack.

Clause 17. The method of clause 1, wherein determining the power transmission requirement and transferring the electrical power comprise controlling transfer of electrical power between the electric tow vehicle and the range-extending trailer such that a state of charge of the vehicle battery pack is maintained within a defined state of charge range during operation of the electric vehicle-trailer combination.

Clause 18. The method of clause 1, wherein forming the electric power coupling comprises forming the electric power connection using a wireless power transfer interface.

Clause 19. The method of clause 1, wherein forming the communication link comprises forming the communication link using a wireless communication protocol.

Clause 20. The method of clause 1, wherein: the electric tow vehicle comprises fluid passages extending through the vehicle battery pack, the trailer comprises fluid passages extending through the trailer battery pack, and the method further comprises: interconnecting the fluid passages of the vehicle battery pack and the trailer battery pack, and flowing a thermal fluid through interconnected fluid passages of the vehicle battery pack and the trailer battery pack, such that the thermal fluid flows between the vehicle battery pack and the trailer battery pack, thereby allowing one of the vehicle battery pack or the trailer battery pack to function as a heat sink for the other during operation of the electric vehicle-trailer combination.

Clause 21. A range-extending trailer for towing by an electric tow vehicle, the range-extending trailer comprising: a trailer battery pack; a trailer electric power coupler, connected to the trailer battery pack, wherein the trailer electric power coupler is configured to form an electric power connection with the electric tow vehicle when the range-extending trailer is coupled to the electric tow vehicle; a trailer power controller, configured to control electrical power flown from the trailer battery pack and through the trailer electric power coupler, wherein the trailer power controller is configured to form a communication link with the electric tow vehicle and exchanges control instructions through the communication link with the electric tow vehicle; a trailer coupler-battery interconnect connecting the trailer battery pack with the trailer electric power coupler; and a trailer mechanical coupler, forming a mechanical connection with the electric tow vehicle and transmitting mechanical forces when the range-extending trailer is coupled to the electric tow vehicle.

Clause 22. The range-extending trailer of clause 21, wherein the trailer coupler-battery interconnect comprises a trailer on-board charger comprising a trailer inverter configured to convert a direct current power flown from the trailer battery pack into alternating current power flown to the trailer electric power coupler.

Clause 23. The range-extending trailer of clause 22, wherein the trailer on-board charger is configured to convert alternating current power flown from an external AC power source into direct current power flown to the trailer battery pack.

Clause 24. The range-extending trailer of clause 22, wherein: the electric tow vehicle comprises a vehicle battery pack and a vehicle on-board charger coupled to the vehicle battery pack and a vehicle electric power coupler, the vehicle on-board charger is configured to convert an alternating current power flown from the vehicle electric power coupler to a direct current power flown to the vehicle battery pack, and the trailer battery pack is configured to operate at a different voltage than the vehicle battery pack is configured to operate at.

Clause 25. The range-extending trailer of clause 24, wherein the trailer battery pack and the vehicle battery pack are configured to operate at different voltages, and the trailer power controller is configured to control the electrical power flown to or from the trailer battery pack based on the voltage difference.

Clause 26. The range-extending trailer of clause 24, wherein the trailer battery pack and the vehicle battery pack are configured to operate at different states of charge.

Clause 27. The range-extending trailer of clause 24, wherein the trailer inverter is configured to convert a direct current power flown from the trailer battery pack into alternating current power flown to the trailer electric power coupler at a constant alternating current voltage.

Clause 28. The range-extending trailer of clause 22, wherein the trailer coupler-battery interconnect further comprises a trailer connector that is configured to form a connection between the trailer on-board charger and an external AC power source, thereby enabling charging of the trailer battery pack by the external AC power source.

Clause 29. The range-extending trailer of clause 21, wherein: the trailer power controller is configured to control electrical power flown to or from the trailer battery pack and through the trailer electric power coupler, and the trailer coupler-battery interconnect comprises a trailer on-board charger that is a bidirectional on-board charger that is configured to convert the direct current power flown from the trailer battery pack into the alternating current power flown to the trailer electric power coupler and is also configured to convert the alternating current power flown from the trailer electric power coupler into the direct current power flown to the trailer battery pack.

Clause 30. The range-extending trailer of clause 29, wherein: the electric tow vehicle comprises a vehicle battery pack and a vehicle on-board charger coupled to the vehicle battery pack and the vehicle electric power coupler, the vehicle on-board charger comprises a vehicle inverter configured to convert direct current power flown from the battery pack into alternating current power flown to the vehicle electric power coupler, and the trailer electric power coupler is configured to receive alternating current power flown from the vehicle electric power coupler.

Clause 31. The range-extending trailer of clause 30, wherein the trailer battery pack is configured to operate at a different voltage than a voltage the vehicle battery pack is configured to operate at.

Clause 32. The range-extending trailer of clause 30, wherein the trailer battery pack is configured to operate at a different state of charge than a state of charge the vehicle battery pack is configured to operate at.

Clause 33. The range-extending trailer of clause 21, wherein: the trailer coupler-battery interconnect comprises a trailer DC-DC converter that is configured to convert direct current power flown from the trailer battery pack at a first voltage to direct current power flown to the trailer electric power coupler at a second voltage, and the trailer power controller is configured to control the direct current power flown to or from the trailer battery pack and through the trailer electric power coupler.

Clause 34. The range-extending trailer of clause 33, wherein: the trailer coupler-battery interconnect further comprises a trailer on-board charger, the trailer on-board charger comprises a trailer connector that is configured to form a connection between the trailer on-board charger and an external AC power source, and the trailer on-board charger is configured to convert alternating current power flown from the external AC power source into direct current power flown to the trailer battery pack.

Clause 35. The range-extending trailer of clause 21, wherein the control instructions, received at the trailer power controller from the electric tow vehicle, comprise a power transfer demand from the trailer battery pack.

Clause 36. The range-extending trailer of clause 35, wherein the power transfer demand is determined based on one or more of (1) a throttle position, (2) a brake pedal position, (3) a state of charge of a vehicle battery pack, and (4) a temperature of the vehicle battery pack.

Clause 37. The range-extending trailer of clause 21, wherein the trailer power controller is configured to control the electrical power flown to or from the trailer battery pack based on one or more of a) the control instructions received at the trailer power controller from the electric tow vehicle, b) a state of charge of the trailer battery pack, and c) a temperature of the trailer battery pack.

Clause 38. The range-extending trailer of clause 21, wherein the electric power connection is a wireless power transfer interface.

Clause 39. The range-extending trailer of clause 21, wherein the trailer power controller is configured to form a communication link with the electric tow vehicle using a wireless communication protocol.

Clause 40. The range-extending trailer of clause 21, further comprising a trailer on-board charger connected to the trailer battery pack and forming an external alternating current (AC) power connection to the trailer battery pack.

Clause 41. An electric vehicle-trailer combination comprising: an electric tow vehicle comprising a vehicle battery pack, a vehicle electric power coupler connected to the vehicle battery pack, a vehicle power controller connected to the vehicle electric power coupler, and a vehicle mechanical coupler configured to form a mechanical connection with the electric tow vehicle and to transmit mechanical forces; and a range-extending trailer comprising: a trailer battery pack, a trailer coupler-battery interconnect connected to the trailer battery pack, a trailer electric power coupler, connected to the trailer coupler-battery interconnect and configured to form an electric power connection with the electric tow vehicle, a trailer power controller configured to control electrical power flown from the trailer battery pack and through the trailer electric power coupler, wherein the trailer power controller is configured to form a communication link with the vehicle power controller and exchange control instructions through the communication link with the vehicle power controller, and a trailer mechanical coupler that is configured to form a mechanical connection with the electric tow vehicle and transmit mechanical forces when the range-extending trailer is towed by the electric tow vehicle.

Clause 42. The electric vehicle-trailer combination of clause 41, wherein: the trailer coupler-battery interconnect comprises a trailer on-board charger that is configured to convert direct current power flown from the trailer battery pack into alternating current power flown to the trailer electric power coupler; and the electric tow vehicle comprises a vehicle on-board charger connecting the vehicle electric power coupler with the vehicle battery pack that is configured to convert alternating current power flown to the vehicle electric power coupler into direct current power flown to the vehicle battery pack.

Clause 43. The electric vehicle-trailer combination of clause 42, wherein: the trailer power controller is configured to control electrical power flown to or from the trailer battery pack and through the trailer electric power coupler, and the vehicle on-board charger comprises a vehicle inverter that is configured to convert DC power flown from the vehicle battery pack to AC power flown to the vehicle electric power coupler.

Clause 44. The electric vehicle-trailer combination of clause 42, wherein: the trailer power controller is configured to control electrical power flown to or from the trailer battery pack and through the trailer electric power coupler, and the vehicle on-board charger is a bidirectional on-board charger that is configured to convert DC power flown from the vehicle battery pack to AC power flown to the vehicle electric power coupler.

Clause 45. The electric vehicle-trailer combination of clause 42, wherein: the trailer power controller is configured to control electrical power flown to or from the trailer battery pack and through the trailer electric power coupler, and the trailer on-board charger is a bidirectional on-board charger that is configured to convert direct current power flown from the trailer battery pack into alternating current power flown to the trailer electric power coupler and to convert alternating current power flown from the trailer electric power coupler into direct current power flown to the trailer battery pack.

These and other embodiments are described further below with reference to the figures.

### BRIEF DESCRIPTION OF THE DRAWINGS

FIG. 1 is a block diagram of an electric vehicle-trailer combination comprising a range-extending trailer and an electric tow vehicle, in accordance with some examples.

FIG. 2 is a side view of an electric vehicle-trailer combination comprising a range-extending trailer and an electric tow vehicle, in accordance with some examples.

FIG. 3 is a process flowchart corresponding to a method of operating an electric vehicle-trailer combination comprising a range-extending trailer and an electric tow vehicle, in accordance with some examples.

FIG. 4 is a block diagram of a computer system that can be implemented as a vehicle power controller or a trailer power controller, in accordance with some examples.

FIG. 5 is a block diagram illustrating components of an electric vehicle-trailer combination that enable transfer of alternating current power from a range-extending trailer to an electric tow vehicle, in accordance with some examples.

FIG. 6 is a block diagram illustrating components of an electric vehicle-trailer combination that enable bidirectional transfer of alternating current power between a range-extending trailer and an electric tow vehicle, in accordance with some examples.

FIG. 7 is a block diagram illustrating components of an electric vehicle-trailer combination that enable bidirectional transfer of direct current power between an electric tow vehicle and a range-extending trailer, in accordance with some examples.

FIG. 8 is a block diagram illustrating components of an electric vehicle-trailer combination that enable bidirectional transfer of direct current power between an electric tow vehicle and a range-extending trailer and charging of the trailer by an external alternating current power source, in accordance with some examples.

FIG. 9 is a schematic plot illustrating direct current voltage and state of charge of a vehicle battery pack and a trailer battery pack, which are coupled components of an electric tow vehicle and a range-extending trailer forming an electric vehicle-trailer combination, over time during three operational regimes, in accordance with some examples.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to avoid unnecessarily obscuring the described concepts. While some concepts will be described in conjunction with the specific embodiments, it will be understood that these embodiments are not intended to be limiting.

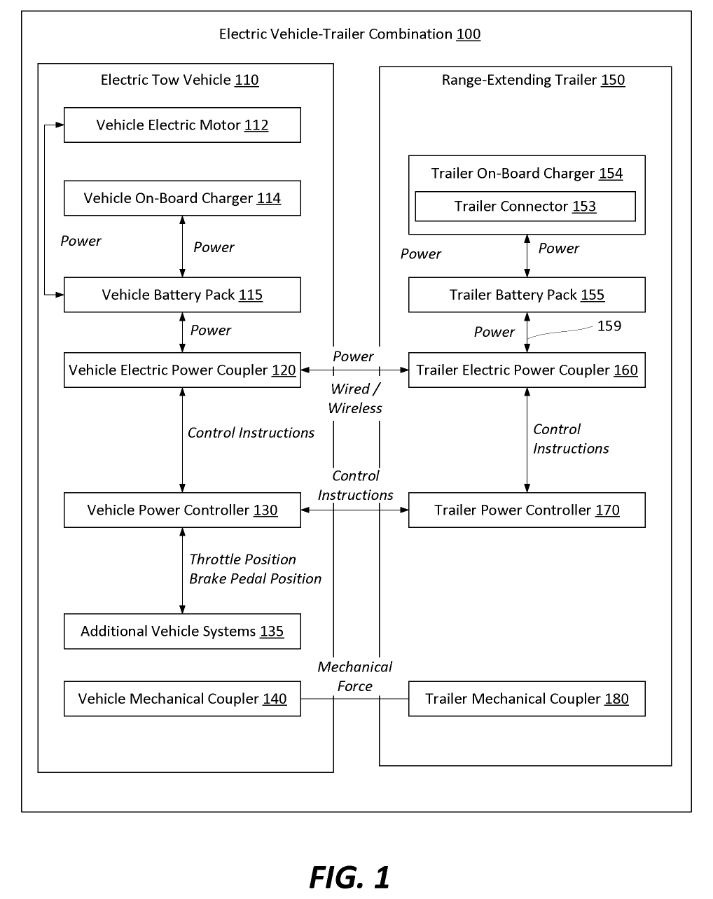

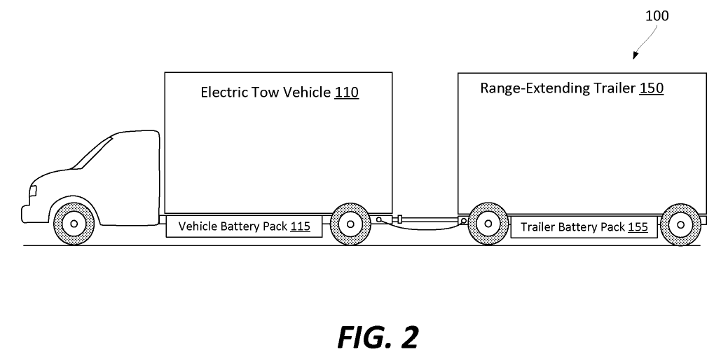

FIG. 1 is a block diagram of an electric vehicle-trailer combination 100 comprising a range-extending trailer 150 and an electric tow vehicle 110, in accordance with some examples. FIG. 2 is a side view of an electric vehicle-trailer combination 100 comprising a range-extending trailer 150 and an electric tow vehicle 110, in accordance with some examples. It should be noted that range-extending trailer 150 and electric tow vehicle 110 can be used independently from each other, e.g., in a decoupled state. For example, electric tow vehicle 110 can be driven without being connected to range-extending trailer 150. Similarly, range-extending trailer 150 can be used independently (e.g., to charge trailer battery pack 155 directly from an external source).

In some examples, electric tow vehicle 110 comprises vehicle electric motor(s) 112 that are used to propel electric tow vehicle 110 and/or to provide regenerative braking of electric tow vehicle 110. Electric tow vehicle 110 can also comprise vehicle battery pack 115 for supplying (and receiving, during regenerative braking) power to vehicle electric motor(s) 112. Electric tow vehicle 110 can also comprise vehicle on-board charger 114 for charging the vehicle battery pack 115 from an external source (e.g., a charging station) and/or range-extending trailer 150. For example, vehicle on-board charger 114 can form a power connection to trailer on-board charger 154 for transferring the power as an alternating current (AC). The vehicle on-board charger 114 converts the alternating current power received from the range-extending trailer 150 into direct current power for charging the vehicle battery pack 115. In some examples, electric tow vehicle 110 also comprises vehicle electric power coupler 120 for forming an electric power connection to range-extending trailer 150. In some examples, electric tow vehicle 110 comprises vehicle power controller 130, which can communicate with range-extending trailer 150 and, in some examples, controls the power transmission between range-extending trailer 150 and electric tow vehicle 110. The vehicle power controller 130 can receive various inputs from additional vehicle systems 135, such as the throttle position, the brake pedal position, the state of charge of vehicle battery pack 115, and the temperature of the vehicle battery pack 115. Finally, electric tow vehicle 110 comprises vehicle mechanical coupler 140 used for connecting to range-extending trailer 150 and towing range-extending trailer 150.

Range-extending trailer 150 comprises trailer battery pack 155 and trailer electric power coupler 160, connected to the trailer battery pack 155 and configured to form the electric power connection with electric tow vehicle 110, or more specifically, with vehicle electric power coupler 120.

In some examples, range-extending trailer 150 also comprises trailer power controller 170, configured to control electrical power flown to or from trailer battery pack 155 and through trailer electric power coupler 160. Trailer power controller 170 is configured to form a communication link with electric tow vehicle 110 or, more specifically, with vehicle power controller 130, and exchange control instructions through the communication link with electric tow vehicle 110. For example, one or both trailer power controller 170 and vehicle power controller 130 can determine the power level for transmission through the electrical power connection. In some examples, the electrical power connection is used to transfer electrical energy from the trailer battery pack 155 into the vehicle battery pack 115 to increase energy available for propulsion by the vehicle electric motor 112. This power level can be determined based on various factors, e.g., related to the operation of electric tow vehicle 110 (e.g., the current power/acceleration demand determined based on the throttle position and/or the brake pedal position), the state of the vehicle battery pack 115 (e.g., state of charge (SOC), temperature, power capabilities), the state of the trailer battery pack 155 (e.g., state of charge (SOC), temperature, power capabilities), and other factors.

Coordinating transfer of electrical energy between trailer battery pack 155 and vehicle battery pack 115 may involve control and software challenges, including sequencing of coupling operations, establishing communication between trailer power controller 170 and vehicle power controller 130, determining a power transmission requirement, varying power based on temperature and state of charge, and ramping power transfer to avoid transients. In some examples, these functions are implemented by one or both of trailer power controller 170 and vehicle power controller 130 using the exchanged control instructions to facilitate energy transfer in a manner compatible with operation of the electric tow vehicle 110.

In some examples, the range-extending trailer 150 further comprises a trailer electric motor connected to the trailer battery pack 155 and controlled by the trailer power controller 170. The trailer electric motor may be configured to operate in a propelling mode and a regenerative-braking mode. The trailer electric motor may assist with maneuvering or stability without serving as a primary propulsion source for the electric vehicle-trailer combination 100.

In some examples, range-extending trailer 150 also comprises trailer mechanical coupler 180, configured to form a mechanical connection with electric tow vehicle 110 and to transmit mechanical forces when range-extending trailer 150 is towed by electric tow vehicle 110.

In some examples, range-extending trailer 150 further comprises trailer on-board charger 154 connected to the trailer battery pack 155 and configured to form an external alternating current (AC) power connection to the trailer battery pack 155.

Various types of trailer battery pack 155 are within the scope, e.g., low-voltage battery packs, high-voltage battery packs, single or multiple packs, single cell or numerous cells in parallel or series, etc. The types of batteries used for trailer battery pack 155 can be different from those of vehicle battery pack 115. In some examples, the relative capacities of trailer battery pack 155 and vehicle battery pack 115 are determined based on additional power needed to tow range-extending trailer 150.

It should be noted that any type of electric tow vehicle 110 that is equipped with vehicle battery pack 115 is within the scope (e.g., hydrogen-power vehicle, plug-in hybrid vehicle, pure electric vehicle, etc.).

Various power transmission methods between electric tow vehicle 110 and range-extending trailer 150 are within the scope, e.g., direct current to direct current (DC-DC) power (directly between the battery packs or, more specifically, between high-voltage distribution boxes (HVDB) on both vehicles), AC power transmission (between the respective on-board chargers, each equipped with an inverter). Furthermore, the transmission could be wired (e.g., flexible wire, slip-ring coupling) and/or wireless (e.g., induction coupling). In some examples, the power couplers are positioned proximate the vehicle mechanical coupler 140 and the trailer mechanical coupler 180 or are routed separately from the vehicle mechanical coupler 140 and the trailer mechanical coupler 180.

In some examples, electrical power transferred from range-extending trailer 150 is delivered to vehicle battery pack 115 for storage prior to being supplied to vehicle electric motor(s) 112. In other examples, electrical power received from range-extending trailer 150 may be supplied directly to vehicle electric motor(s) 112 through the vehicle high-voltage distribution architecture without first being stored in vehicle battery pack 115. In such configurations, vehicle power controller 130 and associated power electronics manage the distribution of incoming electrical energy either to vehicle battery pack 115, to vehicle electric motor(s) 112, or to both, depending on operating conditions. This flexibility allows the electric vehicle-trailer combination 100 to support multiple energy management strategies while maintaining propulsion within electric tow vehicle 110.

In some examples in which alternating current power is transferred from range-extending trailer 150, the alternating current power may be blended with alternating current generated from vehicle battery pack 115 at the propulsion stage by, for example, a vehicle inverter. For example, vehicle inverter 116 and associated motor control electronics may combine alternating current power derived from trailer on-board charger 154 with alternating current power converted from direct current power derived from vehicle battery pack 115 to supply vehicle electric motor(s) 112. In such configurations, vehicle power controller 130 regulates the relative contribution of each power source to meet torque demand while maintaining desired operating limits of vehicle battery pack 115 and trailer battery pack 155.

The power transfer can be performed while electric vehicle-trailer combination 100 is stationary and/or moving (towing). For example, the power transfer can be performed to maintain the state of charge (SOC) of one or both power packs within the set ranges (e.g., to preserve the longevity of the battery packs, maintain their power capabilities, etc.). For example, the power transfer may be performed while the electric vehicle-trailer combination 100 is moving. In some examples, the power transfer is performed while the electric vehicle-trailer combination 100 is propelled by the electric tow vehicle 110.

In some examples, trailer battery pack 155 can be used to maintain vehicle battery pack 115 within a set state of charge (SOC) range (e.g., between 20-80% SOC to preserve the battery life of vehicle battery pack 115). For example, the cycling of trailer battery pack 155 can be prioritized over the cycling of vehicle battery pack 115 (e.g., to reduce the number of cycles experienced by vehicle battery pack 115). Furthermore, the vehicle-trailer power transfer can reduce the power with which vehicle battery pack 115 is discharged (e.g., accelerating, driving uphill) and charged (e.g., using regenerative braking), thereby also preserving the battery life of vehicle battery pack 115.

In some examples, trailer battery pack 155 can be used to expedite the overall charging of electric vehicle-trailer combination 100, e.g., by allowing the charging of both trailer battery pack 155 and vehicle battery pack 115 at the same time (e.g., independently from each other). For example, each trailer battery pack 155 and vehicle battery pack 115 can be connected to separate external chargers.

In some examples, the vehicle-trailer power transfer is enabled by a non-isolated buck-only DC-DC converter to allow operating trailer battery pack 155 and vehicle battery pack 115 at different voltages, e.g., 400V for vehicle battery pack 115 and 800V for trailer battery pack 155. Alternatively, the operating voltages of vehicle battery pack 115 and trailer battery pack 155 are matched. In some examples, the voltage of vehicle battery pack 115 varies during operation, and control of the vehicle-trailer power transfer includes operating the DC-DC converter to accommodate variation in the voltage of vehicle battery pack 115.

In some examples, each trailer battery pack 155 and vehicle battery pack 115 is thermally controlled using a recirculating thermal fluid, e.g., having fluid passages extending through the battery packs. In more specific examples, these thermal circuits of trailer battery pack 155 and vehicle battery pack 115 are interconnected such that the fluid can recirculate between trailer battery pack 155 and vehicle battery pack 115. In these examples, trailer battery pack 155 and vehicle battery pack 115 can function as “heat sinks” for each other, thereby providing extra cooling and/or heating power to each of trailer battery pack 155 and vehicle battery pack 115.

In some examples, electric vehicle-trailer combination 100 is a part of dealer or garage-swappable units to allow in-field upgradability of electric vehicle-trailer combination 100 by adding/changing range-extending trailer 150. For example, range-extending trailer 150 can be switched with another range-extending trailer 150 having characteristics of trailer battery pack 155, e.g., larger capacity, larger current capabilities, etc.

### Examples of Range-Extending Trailers

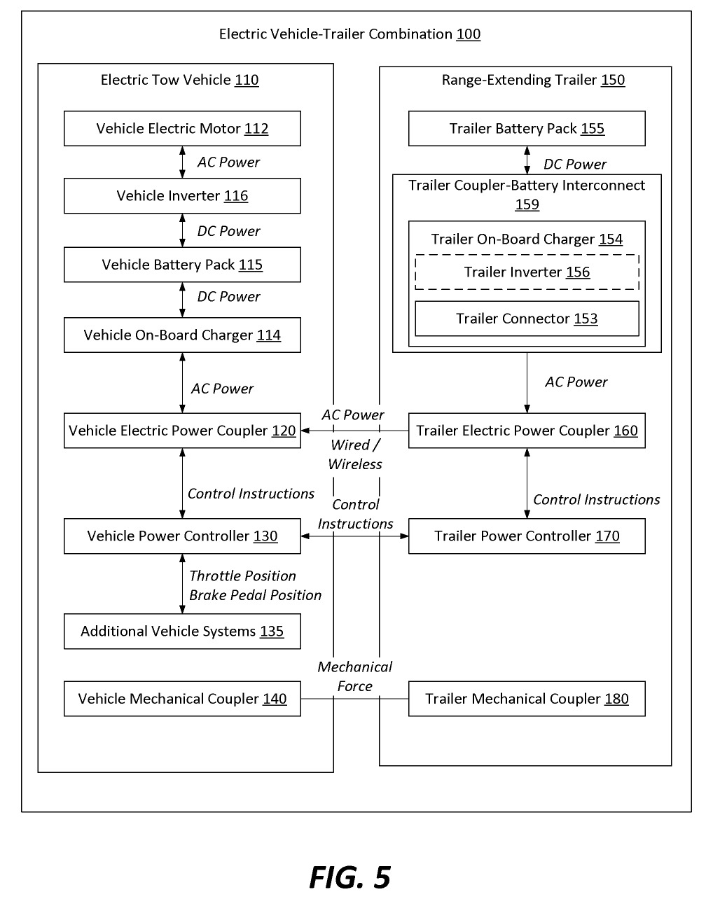

FIG. 5 is a block diagram illustrating components of an electric vehicle-trailer combination 100 and some of its components enabling transfer of alternating current power from a range-extending trailer 150 to an electric tow vehicle 110, in accordance with some examples. In these examples, a range-extending trailer 150 includes a trailer battery pack 155, a trailer electric power coupler 160 electrically connected to the trailer battery pack 155, a trailer power controller 170, and a trailer mechanical coupler 180. The trailer mechanical coupler 180 is configured to form a mechanical connection with a vehicle mechanical coupler 140 of an electric tow vehicle 110, thereby allowing the electric tow vehicle 110 to tow the range-extending trailer 150 and transmit mechanical forces during operation.

The trailer battery pack 155 provides stored electrical energy that may be selectively transferred to the electric tow vehicle 110 through the trailer electric power coupler 160. The trailer power controller 170 controls electrical power flowing from the trailer battery pack 155 and through the trailer electric power coupler 160. The trailer power controller 170 further forms a communication link with the electric tow vehicle 110 and exchanges control instructions with the electric tow vehicle 110, enabling coordinated power transfer between the trailer battery pack 155 and a vehicle battery pack 115.

In some examples, vehicle inverter 116 is electrically coupled between vehicle battery pack 115 and vehicle electric motor(s) 112. In these examples, vehicle battery pack 115 provides direct current power to vehicle inverter 116, and vehicle inverter 116 converts the direct current power into alternating current power supplied to vehicle electric motor(s) 112 to propel electric tow vehicle 110. Vehicle on-board charger 114 is electrically coupled with vehicle electric power coupler 120 and vehicle battery pack 115 and is configured to convert alternating current power received through vehicle electric power coupler 120 into direct current power for charging vehicle battery pack 115. As such, electrical energy received from range-extending trailer 150 as alternating current power through vehicle electric power coupler 120 may be converted by vehicle on-board charger 114 into direct current power stored in vehicle battery pack 115, which is then converted by vehicle inverter 116 into alternating current power for operation of vehicle electric motor(s) 112. In these and other examples, vehicle inverter 116 may comprise or be integrated with a motor controller configured to control operation of vehicle electric motor(s) 112. The motor controller may generate control signals for vehicle inverter 116 to regulate frequency, phase, and amplitude of alternating current power supplied to vehicle electric motor(s) 112 based on torque or speed commands. In some examples, the motor controller is implemented as part of vehicle inverter 116 within a common housing. In other examples, the motor controller is a separate electronic control unit electrically coupled with vehicle inverter 116 and vehicle power controller 130, thereby enabling coordinated control of propulsion in response to power available from vehicle battery pack 115, including electrical energy received from range-extending trailer 150.

This configuration addresses the reduction in driving range experienced by electric vehicles when towing. Instead of relying on a trailer-mounted propulsion system, electrical energy from the trailer battery pack 155 is transferred to the electric tow vehicle 110, allowing the electric tow vehicle 110 to continue using its native propulsion architecture. The trailer mechanical coupler 180 transmits towing forces without introducing propulsion torque from the range-extending trailer 150, thereby avoiding the complexity, cost, and functional safety concerns associated with motorized trailers.

In alternative examples, the communication link between the trailer power controller 170 and the electric tow vehicle 110 may be implemented using wired communication or a wireless communication protocol. The trailer mechanical coupler 180 and vehicle mechanical coupler 140 may be implemented using a ball hitch, pintle hitch, kingpin and fifth-wheel hitch, a universal joint, or other suitable mechanical coupling. Control of power transfer may be primarily determined by the trailer power controller 170, by a vehicle power controller 130 of the electric tow vehicle 110, or by cooperative control between both controllers.

AC power transfer between the electric tow vehicle 110 and the range-extending trailer 150 provides several technical and system-level benefits that address the challenges of extending driving range while maintaining a simple and safe architecture.

A primary benefit of AC power transfer is compatibility with existing vehicle charging architectures. Most electric tow vehicles 110 already include a vehicle on-board charger 114 designed to accept AC input and convert that AC power into DC power for charging the vehicle battery pack 115. By transferring energy from the trailer battery pack 155 as AC power through the trailer electric power coupler 160 and the vehicle electric power coupler 120, the system leverages the vehicle on-board charger 114 without requiring modifications to the vehicle’s high-voltage DC bus. This avoids direct electrical coupling of dissimilar DC battery systems and reduces integration complexity.

AC power transfer also improves safety and robustness relative to direct DC-to-DC coupling. Direct DC power transfer typically requires close matching of voltage levels between the trailer battery pack 155 and the vehicle battery pack 115, or the use of high-power DC-DC converters operating across wide voltage ranges. Such arrangements increase electrical stress, fault energy, and system complexity. In contrast, AC transfer provides electrical isolation through the power electronics of the trailer on-board charger 154, when present, and the vehicle on-board charger 114, reducing the risk of fault propagation between the trailer and the electric tow vehicle 110.

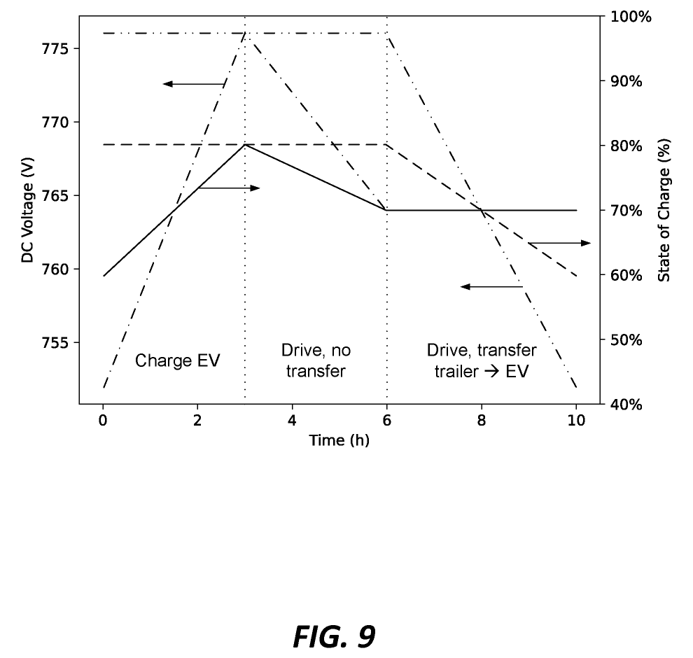

FIG. 9 is a schematic plot illustrating DC voltage and state of charge of a vehicle battery pack 115 and a trailer battery pack 155 over time during operation of an electric vehicle-trailer combination 100, in accordance with some examples.

In FIG. 9, the horizontal axis represents time (h) and is divided into three operational regimes of the vehicle battery pack 115 and the trailer battery pack 155. The left vertical axis represents the direct current (DC) voltage of the vehicle battery pack 115 and the trailer battery pack 155 at a given time. The right vertical axis represents the state of charge (SOC) of the vehicle battery pack 115 and the trailer battery pack 155 at a given time. In the illustrated example, each battery pack is assumed to have a capacity of 50 kWh and a nominal voltage of 800 V at 100% state of charge (SOC). The solid line represents the SOC of the vehicle battery pack 115, and the dashed line represents the state of charge (SOC) of the trailer battery pack 155. The dash-dot line represents the DC voltage of the vehicle battery pack 115, and the dash-dot-dot line represents the DC voltage of the trailer battery pack 155.

The first operational regime corresponds to charging the electric tow vehicle 110. In this regime, the state of charge (SOC) and the DC voltage of the vehicle battery pack 115 both increase, for example from about 60% state of charge (SOC) toward about 80% state of charge (SOC), while the state of charge (SOC) and the DC voltage of the trailer battery pack 155 remain substantially unchanged at about 80% state of charge (SOC). Because DC voltage is directly correlated with state of charge (SOC), the dash-dot line representing the DC voltage of the vehicle battery pack 115 rises together with the solid state of charge (SOC) line of the vehicle battery pack 115.

The second operational regime corresponds to driving the electric tow vehicle 110 without transfer of power from the trailer battery pack 155 to the vehicle battery pack 115. In this regime, the state of charge (SOC) and the DC voltage of the vehicle battery pack 115 both decrease, for example from about 80% state of charge (SOC) toward about 70% state of charge (SOC), while the state of charge (SOC) and the DC voltage of the trailer battery pack 155 remain substantially unchanged at about 80% state of charge (SOC). The plot visually demonstrates that the DC voltage of the vehicle battery pack 115 drops in proportion to its state of charge (SOC), while the DC voltage of the trailer battery pack 155 remains elevated.

The third operational regime corresponds to driving the electric tow vehicle 110 with transfer of power from the trailer battery pack 155 to the vehicle battery pack 115. In this regime, the state of charge (SOC) and the DC voltage of the vehicle battery pack 115 remain substantially constant, for example at about 70% state of charge (SOC), while the state of charge (SOC) and the DC voltage of the trailer battery pack 155 decrease, for example from about 80% state of charge (SOC) toward about 60% state of charge (SOC). DC voltages track state of charge (SOC) directly, resulting in a voltage mismatch between the vehicle battery pack 115 and the trailer battery pack 155 during cross-transfer. As the trailer battery pack 155 discharges, its DC voltage decreases relative to the DC voltage of the vehicle battery pack 115, thereby requiring active voltage matching, tracking, or DC-DC conversion to maintain controlled power transfer between the battery packs.

Another advantage of AC power transfer is architectural simplicity and reuse of standardized components. AC charging standards, connectors, protection schemes, and control strategies are already well established for electric vehicles. Using AC power transfer allows the range-extending trailer 150 to interface with the electric tow vehicle 110 in a manner analogous to an external charging source. Furthermore, AC power transfer supports flexibility and scalability across different vehicle platforms. A single range-extending trailer 150 can be used with multiple electric tow vehicles 110 having different battery voltages, chemistries, or power ratings. Alternating current power transfer leverages existing on-board chargers and avoids direct coupling of dissimilar direct current battery system voltages.

In some examples, the range-extending trailer 150 further includes a trailer coupler-battery interconnect 159 connecting the trailer battery pack 155 with the trailer electric power coupler 160. The trailer coupler-battery interconnect 159 provides an electrical pathway between the trailer battery pack 155 and the trailer electric power coupler 160. In some examples, the trailer coupler-battery interconnect 159 is a wire harness. In other examples, as described below with reference to FIGS. 5, 6, 7 and 8, the trailer coupler-battery interconnect 159 may comprise active or passive electronic components. This arrangement allows power conditioning, isolation, voltage conversion, and monitoring functions to be implemented between the trailer battery pack 155 and the trailer electric power coupler 160.

As illustrated in FIG. 5, in some examples, the trailer coupler-battery interconnect 159 comprises a trailer on-board charger 154 that converts direct current power flowing from the trailer battery pack 155 into alternating current power flowing to the trailer electric power coupler 160. This configuration enables AC power transfer from the range-extending trailer 150 to the electric tow vehicle 110. In some examples, the trailer on-board charger 154 is configured to flow AC power to the trailer electric power coupler 160 at a nominal voltage of about 240 V. In other examples, the AC voltage may be from about 100 V to about 120 V, from about 200 V to about 240 V, or more narrowly from about 208 V to about 240 V. In some examples, the AC power may be single-phase AC power or three-phase AC power. In some examples, the nominal voltage of the AC power transferred between the range-extending trailer 150 and the electric tow vehicle 110 to remains substantially constant during charging and discharging of the vehicle battery pack 115 and the trailer battery pack 155.

In some examples, the trailer on-board charger 154 comprises a trailer inverter 156 that converts direct current power flowing from the trailer battery pack 155 into alternating current power flowing to the trailer electric power coupler 160. Including the trailer inverter 156 enables a unidirectional charging architecture while still allowing the trailer battery pack 155 to supply AC power to the electric tow vehicle 110. This approach may reduce cost and system complexity compared to fully bidirectional charger implementations. In alternative examples, the trailer inverter 156 may be implemented as a discrete component within the trailer coupler-battery interconnect 159 or integrated with other power electronics of the range-extending trailer 150.

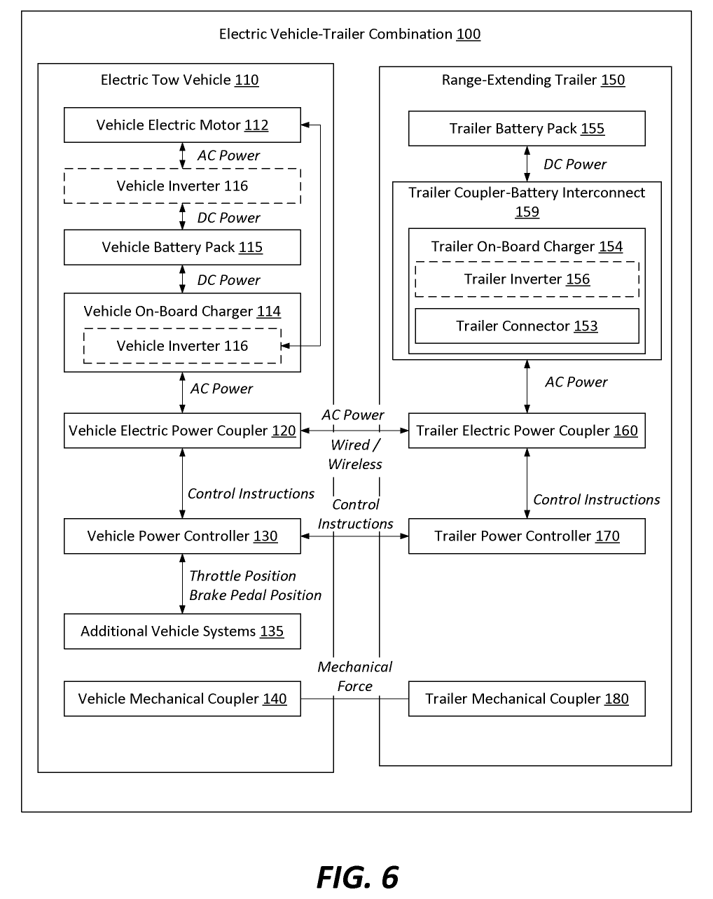

FIG. 6 is a block diagram illustrating components of an electric vehicle-trailer combination 100 and some of its components enabling bidirectional transfer of alternating current power between a range-extending trailer 150 and an electric tow vehicle 110, in accordance with some examples. In these examples, the trailer power controller 170 is configured to control electrical power flowing to or from the trailer battery pack 155 through the trailer electric power coupler 160. In some of these examples, the trailer on-board charger 154 is a bidirectional on-board charger. A bidirectional on-board charger is a power electronics device configured to convert alternating current power to direct current power for charging a battery pack and to convert direct current power from the battery pack into alternating current power for delivery to an external load or power interface. The bidirectional trailer on-board charger 154 converts direct current power flowing from the trailer battery pack 155 into alternating current power flowing to the trailer electric power coupler 160 and converts alternating current power flowing from the trailer electric power coupler 160 into direct current power flowing to the trailer battery pack 155. This bidirectional capability allows the range-extending trailer 150 to both supply energy to the electric tow vehicle 110 and receive energy for charging. In alternative examples, bidirectional operation may be enabled only under specific conditions determined by the trailer power controller 170, such as battery state of charge, temperature, or commanded operating modes. In some other examples, the trailer on-board charger 154 is a unidirectional on-board charger, and the trailer coupler-battery interconnect 159 further comprises a trailer inverter 156.

In some examples, vehicle inverter 116 is configured as a separate component electrically coupled between vehicle battery pack 115 and vehicle electric motor(s) 112, such that vehicle inverter 116 receives direct current power from vehicle battery pack 115 and converts the direct current power into alternating current power supplied to vehicle electric motor(s) 112 to propel electric tow vehicle 110. In other examples, vehicle inverter 116 is implemented as a component of vehicle on-board charger 114, as illustrated by the alternative dashed-line configurations in FIG. 6. In these examples, direct current power from vehicle battery pack 115 is supplied to vehicle on-board charger 114, and vehicle inverter 116 within vehicle on-board charger 114 converts the direct current power into alternating current power delivered to vehicle electric motor(s) 112.

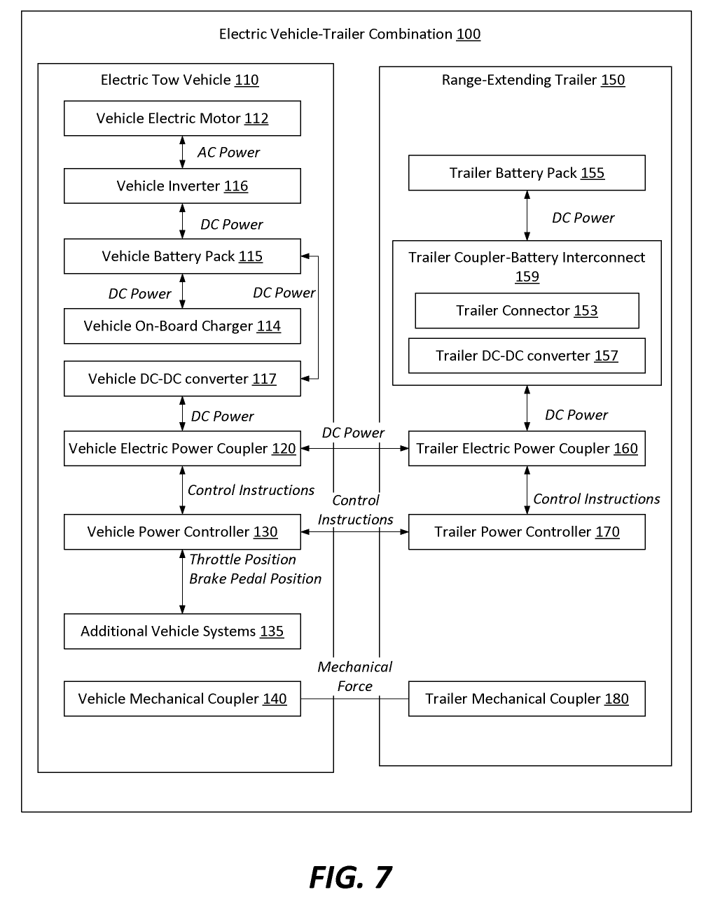

FIG. 7 is a block diagram illustrating components of an electric vehicle-trailer combination 100 that enable bidirectional transfer of direct current power between an electric tow vehicle 110 and a range-extending trailer 150, in accordance with some examples. In some of these examples, the trailer coupler-battery interconnect 159 further comprises a trailer connector 153 configured to form a connection between the trailer on-board charger 154 and an external AC power source. The trailer connector 153 enables charging of the trailer battery pack 155 by an external power source. The external power source may be an AC source, in which case the trailer on-board charger 154 converts incoming AC power into DC power for charging the trailer battery pack 155, or a DC charging source that bypasses the trailer on-board charger 154. This capability allows the trailer battery pack 155 to be charged independently of the electric tow vehicle 110, improving operational flexibility.

In some examples, the trailer coupler-battery interconnect 159 comprises a trailer DC-DC converter 157 that converts direct current power flowing from the trailer battery pack 155 at a first voltage to direct current power flowing to the trailer electric power coupler 160 at a second voltage. In some examples, the electric tow vehicle 110 comprises a vehicle DC-DC converter 117, and DC power may be transferred directly between the trailer battery pack 155 and the vehicle battery pack 115. DC-DC converters may be lighter and more thermally efficient than inverter-based solutions. In some examples, the DC voltage of the trailer battery pack 155 is between about 300 V and about 900 V, between about 350 V and about 800 V, or even between about 400 V and about 800 V.

In some examples, the trailer coupler-battery interconnect 159 comprises the trailer DC-DC converter 157. In other examples, the trailer DC-DC converter 157 is a separate component coupled with both the trailer coupler-battery interconnect 159 and the trailer electric power coupler 160. In some examples, as described above with reference to FIG. 5, vehicle inverter 116 is electrically coupled between vehicle battery pack 115 and vehicle electric motor(s) 112. In these examples, vehicle battery pack 115 provides direct current power to vehicle inverter 116, and vehicle inverter 116 converts the direct current power into alternating current power supplied to vehicle electric motor(s) 112 to propel electric tow vehicle 110.

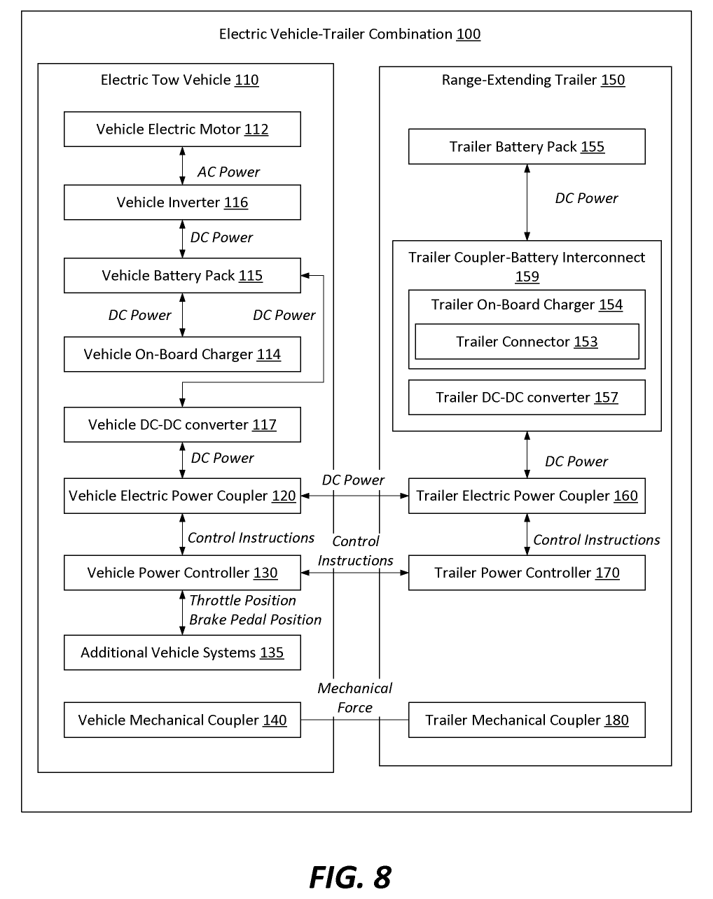

FIG. 8 is a block diagram illustrating components of an electric vehicle-trailer combination 100 that enable bidirectional transfer of direct current power between an electric tow vehicle 110 and a range-extending trailer 150 and charging of the range-extending trailer 150 by an external alternating current power source, in accordance with some examples. In these examples, the range-extending trailer 150 further comprises a trailer connector 153 that allows charging of the trailer battery pack 155 from external AC sources. In these examples, charging of the trailer battery pack 155 from the electric tow vehicle 110 occurs only using DC power. The trailer battery pack 155 may still also be charged from an external DC power source or from the vehicle battery pack 115. In some examples, as described above with reference to FIG. 5, vehicle inverter 116 is electrically coupled between vehicle battery pack 115 and vehicle electric motor(s) 112. In these examples, vehicle battery pack 115 provides direct current power to vehicle inverter 116, and vehicle inverter 116 converts the direct current power into alternating current power supplied to vehicle electric motor(s) 112 to propel electric tow vehicle 110.

In some examples, control instructions received at the trailer power controller 170 from the electric tow vehicle 110 comprise a power transfer demand specifying delivery of electrical energy from the trailer battery pack 155. This arrangement allows the electric tow vehicle 110 to request supplemental energy as needed, thereby mitigating range reduction during towing operations.

In some examples, the power transfer demand is determined based on one or more of a throttle position, a brake pedal position, a state of charge of the vehicle battery pack 115, and a temperature of the vehicle battery pack 115. These inputs allow dynamic adjustment of power transfer to optimize vehicle performance, battery longevity, and safety.

In some examples, the trailer power controller 170 controls electrical power flowing to or from the trailer battery pack 155 based on one or more of control instructions received from the electric tow vehicle 110, a state of charge of the trailer battery pack 155, and a temperature of the trailer battery pack 155. This local control improves robustness by allowing the range-extending trailer 150 to protect the trailer battery pack 155 independently.

### Examples of Electric Vehicle-Trailer Combinations Comprising Range-Extending Trailers

Returning to FIG. 1, an electric vehicle-trailer combination 100 includes an electric tow vehicle 110 and a range-extending trailer 150 mechanically and electrically coupled to one another. The electric tow vehicle 110 includes a vehicle battery pack 115, a vehicle electric power coupler 120 connected to the vehicle battery pack 115, a vehicle power controller 130 connected to the vehicle electric power coupler 120, and a vehicle mechanical coupler 140. The range-extending trailer 150 includes a trailer battery pack 155, a trailer electric power coupler 160 connected to the trailer battery pack 155, a trailer power controller 170, and a trailer mechanical coupler 180. The trailer mechanical coupler 180 forms a mechanical connection with the vehicle mechanical coupler 140 to transmit mechanical towing forces when the range-extending trailer 150 is towed by the electric tow vehicle 110.

The trailer electric power coupler 160 and the vehicle electric power coupler 120 together form an electric power connection between the range-extending trailer 150 and the electric tow vehicle 110. The trailer power controller 170 controls electrical power flowing from the trailer battery pack 155 and through the trailer electric power coupler 160. The trailer power controller 170 forms a communication link with the vehicle power controller 130 and exchanges control instructions through that communication link, allowing coordinated control of energy transfer between the trailer battery pack 155 and the vehicle battery pack 115.

This architecture addresses the reduction in driving range that occurs when towing with electric vehicles. Electrical energy stored in the trailer battery pack 155 is transferred into the electric tow vehicle 110, allowing the vehicle to continue operating using its native drivetrain. By keeping propulsion within the electric tow vehicle 110, the system remains simpler and avoids functional safety concerns associated with multiple propulsion sources.

In alternative examples, the communication link between the trailer power controller 170 and the vehicle power controller 130 may be wired or wireless. Control authority for power transfer may be centralized in the vehicle power controller 130, centralized in the trailer power controller 170, or shared between both controllers. The vehicle mechanical coupler 140 and the trailer mechanical coupler 180 may be implemented using any suitable towing interface without affecting the electrical architecture.

Returning to FIG. 5, the electric vehicle-trailer combination 100 further includes a trailer coupler-battery interconnect 159 that connects the trailer battery pack 155 with the trailer electric power coupler 160. The trailer coupler-battery interconnect 159 provides an electrical pathway between energy storage in the range-extending trailer 150 and the electric power interface to the electric tow vehicle 110. The trailer coupler-battery interconnect 159 allows power conversion, isolation, protection, and monitoring functions to be implemented between the trailer battery pack 155 and the trailer electric power coupler 160. In some examples, the trailer coupler-battery interconnect 159 is a wire harness. In other examples, the trailer coupler-battery interconnect 159 includes active or passive electronic components, such as chargers, inverters, converters, sensors, or protection devices.

Returning to FIG. 6, the trailer coupler-battery interconnect 159 includes a trailer on-board charger 154 that converts direct current power flowing from the trailer battery pack 155 into alternating current power flowing to the trailer electric power coupler 160. The electric tow vehicle 110 includes a vehicle on-board charger 114 that connects the vehicle electric power coupler 120 with the vehicle battery pack 115 and converts alternating current power flowing to the vehicle electric power coupler 120 into direct current power flowing to the vehicle battery pack 115. This AC-to-DC interface between the range-extending trailer 150 and the electric tow vehicle 110 allows energy transfer using existing vehicle charging architectures. The electric tow vehicle 110 may treat the range-extending trailer 150 as an AC energy source, similar to an external charging station, thereby avoiding direct DC coupling between dissimilar battery systems.

In some examples, the trailer on-board charger 154 may supply AC power at voltages commonly associated with Level 1 and Level 2 charging. For example, the AC voltage may be in a range from about 100 V to about 240 V, with narrower ranges including from about 100 V to about 120 V or from about 200 V to about 240 V, or more narrowly from about 208 V to about 240 V.

In some examples, the trailer power controller 170 controls electrical power flowing to or from the trailer battery pack 155 through the trailer electric power coupler 160, and the vehicle on-board charger 114 includes a vehicle inverter 116. The vehicle inverter 116 converts direct current power flowing from the vehicle battery pack 115 into alternating current power flowing to the vehicle electric power coupler 120. This configuration enables AC power to be supplied from the electric tow vehicle 110 to the range-extending trailer 150 for, for example, charging the trailer battery pack 155 or balancing energy between the two systems. Including the vehicle inverter 116 enables bidirectional energy capability even when the vehicle on-board charger 114 itself is unidirectional. In alternative examples, the inverter function may be integrated into the vehicle on-board charger 114 or implemented as a separate power electronics module electrically connected to the vehicle battery pack 115.

In some examples, the trailer power controller 170 controls electrical power flowing to or from the trailer battery pack 155 through the trailer electric power coupler 160, and the vehicle on-board charger 114 is a bidirectional on-board charger. The bidirectional vehicle on-board charger 114 converts direct current power flowing from the vehicle battery pack 115 into alternating current power flowing to the vehicle electric power coupler 120. This bidirectional configuration allows energy to flow from the electric tow vehicle 110 to the range-extending trailer 150, enabling charging of the trailer battery pack 155 from the vehicle battery pack 115 when appropriate. This supports flexible energy management strategies, such as preconditioning or balancing state of charge between the vehicle and trailer. In alternative examples, bidirectional operation may be selectively enabled based on battery state of charge, temperature, or operating conditions determined by one or both of the vehicle power controller 130 or the trailer power controller 170.

In some examples, the trailer power controller 170 controls electrical power flowing to or from the trailer battery pack 155 through the trailer electric power coupler 160, and the trailer on-board charger 154 is a bidirectional on-board charger. The bidirectional trailer on-board charger 154 converts direct current power flowing from the trailer battery pack 155 into alternating current power flowing to the trailer electric power coupler 160 and converts alternating current power flowing from the trailer electric power coupler 160 into direct current power flowing to the trailer battery pack 155. This configuration allows the range-extending trailer 150 to both supply energy to the electric tow vehicle 110 and receive energy from the electric tow vehicle 110 or from an external AC source. This bidirectional capability improves overall system flexibility, allows the trailer battery pack 155 to be used as a mobile energy resource, and allows concurrent charging of both the electric tow vehicle 110 and the range-extending trailer 150. In alternative examples, bidirectional operation may be constrained to specific operating modes or limited power levels to preserve battery life or maintain thermal limits.

Returning to FIG. 7, in some examples, the electric vehicle-trailer combination 100 includes a trailer coupler-battery interconnect 159 that further comprises a trailer connector 153 configured to form a connection between the range-extending trailer 150 and an external power source. In these examples, the trailer connector 153 enables charging of the trailer battery pack 155 from an external power source independently of the electric tow vehicle 110.

In some examples, the external power source connected through the trailer connector 153 is a direct current power source. In these examples, direct current power flows from the trailer connector 153 to the trailer battery pack 155, optionally bypassing a trailer on-board charger 154. This allows the range-extending trailer 150 to be charged directly from external DC charging infrastructure, improving flexibility and reducing charging time in certain operating environments.

In some examples, the electric tow vehicle 110 comprises a vehicle DC-DC converter 117 coupled with the vehicle electric power coupler 120 and the vehicle battery pack 115. The vehicle DC-DC converter 117 is configured to convert direct current power flowing from the trailer electric power coupler 160 to a DC voltage suitable for charging the vehicle battery pack 115, including matching the voltage of the trailer battery pack 155. This allows DC power transferred from the range-extending trailer 150 to be conditioned to match the voltage of the vehicle battery pack 115.

In some examples, the vehicle DC-DC converter 117 is further configured to convert direct current power flowing from the vehicle battery pack 115 to a different DC voltage suitable for charging the trailer battery pack 155. This enables charging of the range-extending trailer 150 from the electric tow vehicle 110 when appropriate. Together, this architecture supports bidirectional DC energy transfer between the electric tow vehicle 110 and the range-extending trailer 150, as well as charging of the trailer battery pack 155 from an external DC power source via the trailer connector 153.

Returning to FIG. 8, in some examples, the trailer coupler-battery interconnect 159 includes a trailer DC-DC converter 157 that converts direct current power flowing from the trailer battery pack 155 at a first voltage to direct current power flowing to the trailer electric power coupler 160 at a second voltage. The trailer power controller 170 controls electrical power flowing to or from the trailer battery pack 155 and through the

trailer electric power coupler 160. This DC-based architecture allows direct DC power transfer between the range-extending trailer 150 and the electric tow vehicle 110. DC-DC converters may be less expensive, lighter, and more thermally efficient than inverter-based AC solutions. This architecture also allows charging of the trailer battery pack 155 via the trailer connector 153 from an external DC power source. In some examples, the DC voltage of the trailer battery pack 155 may fall within a range from about 300 V to about 900 V, with narrower ranges including from about 350 V to about 800 V or from about 400 V to about 800 V.

In some examples, the trailer coupler-battery interconnect 159 further includes a trailer on-board charger 154. The trailer on-board charger 154 includes a trailer connector 153 configured to form a connection with an external AC power source, and the trailer on-board charger 154 converts alternating current power flowing from the external AC power source into direct current power flowing to the trailer battery pack 155. This configuration allows the trailer battery pack 155 to be charged from external AC infrastructure while maintaining DC-only energy transfer between the range-extending trailer 150 and the electric tow vehicle 110. The trailer battery pack 155 may also be charged from an external DC power source or from the vehicle battery pack 115.

### Examples of Methods for Operating Electric Vehicle-Trailer Combinations

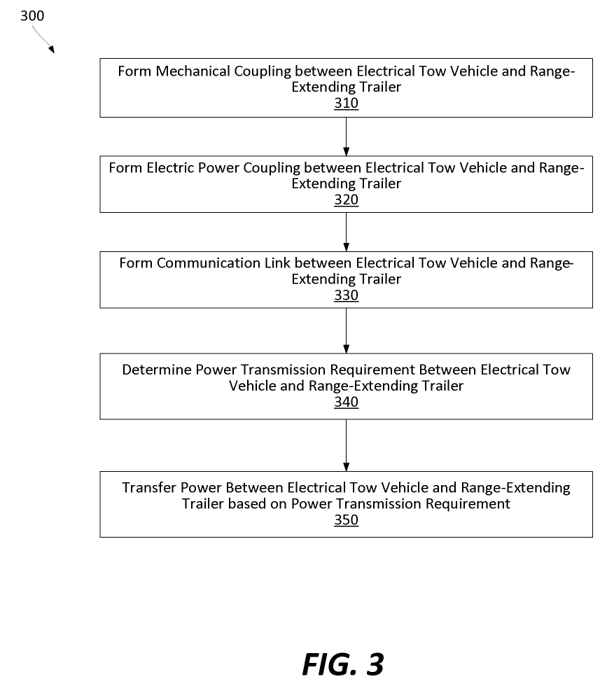

FIG. 3 is a process flowchart corresponding to a method of operating an electric vehicle-trailer combination comprising a range-extending trailer and an electric tow vehicle, in accordance with some examples. Various examples of electric vehicle-trailer combination 100 are described above. Specifically, electric vehicle-trailer combination 100 comprises electric tow vehicle 110 and range-extending trailer 150, each comprising a battery pack.

Method 300 may commence with forming a mechanical coupling between an electric tow vehicle 110 and a range-extending trailer 150 at 310. At 310, a vehicle mechanical coupler 140 of the electric tow vehicle 110 is mechanically coupled with a trailer mechanical coupler 180 of the range-extending trailer 150. The mechanical coupling enables transmission of mechanical towing forces from the electric tow vehicle 110 to the range-extending trailer 150 during operation of the electric vehicle-trailer combination 100.

The method 300 may proceed with forming an electric power coupling between the electric tow vehicle 110 and the range-extending trailer 150 at 320. At 320, a vehicle electric power coupler 120 connected to a vehicle battery pack 115 is electrically coupled with a trailer electric power coupler 160 connected to a trailer battery pack 155. As described above, the electric power coupling may be implemented using a wired electrical connection, a wireless power transfer interface, or combinations thereof. In some examples, the electric power coupling is configured to transfer alternating current power between the electric tow vehicle 110 and the range-extending trailer 150. In other examples, the electric power coupling is configured to transfer direct current power between the electric tow vehicle 110 and the range-extending trailer 150. The electric power coupling establishes an electrical pathway for transferring electrical power between the electric tow vehicle 110 and the range-extending trailer 150 without requiring mechanical propulsion from the trailer.

The method 300 may further include forming a communication link between the electric tow vehicle 110 and the range-extending trailer 150 at 330. At 330, a trailer power controller 170 forms a communication link with the electric tow vehicle 110 and exchanges control instructions with the electric tow vehicle 110. In some examples, the communication link is formed between the trailer power controller 170 and a vehicle power controller 130 of the electric tow vehicle 110, enabling coordinated control of electrical power transfer between the trailer battery pack 155 and the vehicle battery pack 115.

The method 300 may further include determining a power transmission requirement between the electric tow vehicle 110 and the range-extending trailer 150 at 340. At 340, the power transmission requirement may be determined by the trailer power controller 170, by the vehicle power controller 130, or cooperatively by both controllers. The power transmission requirement may be determined based on one or more operating parameters, including throttle position, brake pedal position, a state of charge of the vehicle battery pack 115, a state of charge of the trailer battery pack 155, temperature conditions, or other operating states of the electric vehicle-trailer combination 100.

The method 300 may further include transferring power between the electric tow vehicle 110 and the range-extending trailer 150 based on the power transmission requirement at 350. At 350, electrical power is transferred between the trailer battery pack 155 and the vehicle battery pack 115 through the trailer electric power coupler 160 and the vehicle electric power coupler 120 under control of the trailer power controller 170 and the vehicle power controller 130. This transfer of electrical energy supplements energy available to the electric tow vehicle 110 during towing, thereby mitigating range reduction while maintaining a propulsion architecture in which the electric tow vehicle 110 remains responsible for propulsion.

### Computer System Examples

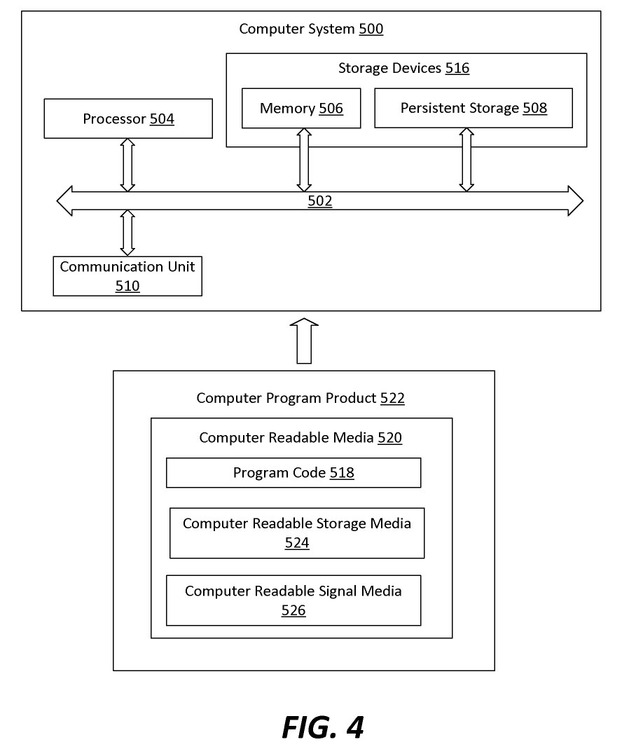

FIG. 4 is a block diagram of computer system 500, which can be operable as vehicle power controller 130 and/or trailer power controller 170. In some examples, one or more components of a computer system 500 are implemented as onboard components of an electric tow vehicle 110 or as onboard components of a range-extending trailer 150. In various examples, computer system 500 includes communications framework 502 (e.g., a bus), which provides communications between processor unit 504, memory 506, persistent storage 508, and communications unit 510. Communications unit 510 provides for communications with other vehicle systems or devices. In these illustrative examples, communications unit 510 may be a network interface card (e.g., a controller area network (CAN)-bus device), a universal serial bus (USB) interface, or other suitable communications device/interface.

Processor unit 504 serves to execute instructions for software that may be loaded into memory 506. Processor unit 504 may be a number of processors, a multi-processor core, or some other type of processor, depending on the particular implementation.

Memory 506 and persistent storage 508 are examples of storage devices 516, e.g., computer-readable storage components. Memory 506 can be a random access memory (RAM) or any other suitable volatile or non-volatile storage device. Persistent storage 508 may take various forms, e.g., a hard drive, a flash memory, or some combination of the above. Instructions for the operating system, applications, and/or programs may be located in storage device 516. The processes of the different examples may be performed by processor unit 504 using computer-implemented instructions, which may be located in a memory, such as memory 506.

These instructions are referred to as program code, computer-usable program code, or computer-readable program code. The program code in the different examples may be embodied in different physical or computer-readable storage media, such as memory 506 or persistent storage 508. Program code 518 is located in a functional form on computer-readable media 520 that may be loaded onto or transferred to computer system 500 for execution by processor unit 504. Program code 518 and computer-readable media 520 form computer program product 522 in these illustrative examples. In one example, computer-readable media 520 may be computer-readable storage media 524 or computer-readable signal media 526.

In these illustrative examples, computer-readable storage media 524 is a physical or tangible storage device used to store program code 518 rather than a medium that propagates or transmits program code 518.

Alternatively, program code 518 may be transferred to computer system 500 using computer-readable signal media 526. Computer-readable signal media 526 may be, for example, a propagated data signal containing program code 518. For example, computer-readable signal media 526 may be an electromagnetic signal, an optical signal, and/or any other suitable type of signal. These signals may be transmitted over communications links, such as wireless communications links, an optical fiber cable, a coaxial cable, a wire, and/or any other suitable type of communications link.

### Conclusion

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. A method of operating an electric vehicle-trailer combination, the electric vehicle-trailer combination comprising an electric tow vehicle and a range-extending trailer, the method comprising:
forming a mechanical coupling between the electric tow vehicle and the range-extending trailer by mechanically coupling a vehicle mechanical coupler of the electric tow vehicle with a trailer mechanical coupler of the range-extending trailer, thereby enabling transmission of mechanical towing forces between the electric tow vehicle and the range-extending trailer when the range-extending trailer is towed by the electric tow vehicle;
forming an electric power coupling between the electric tow vehicle and the range-extending trailer by electrically coupling (a) a vehicle electric power coupler connected to a vehicle battery pack of the electric tow vehicle with (b) a trailer electric power coupler connected to a trailer battery pack of the range-extending trailer, thereby establishing an electrical pathway for transferring electrical power between the electric tow vehicle and the range-extending trailer;
forming a communication link between a trailer power controller of the range-extending trailer and a vehicle power controller of the electric tow vehicle for exchanging control instructions through the communication link between the range-extending trailer and the electric tow vehicle;
determining a power transmission requirement, using one or both of the trailer power controller or the vehicle power controller, for transferring electrical power between the electric tow vehicle and the range-extending trailer based on one or more operating parameters of the electric vehicle-trailer combination; and
transferring the electrical power between the trailer electric power coupler and the vehicle electric power coupler in accordance with the power transmission requirement, under control of the trailer power controller of the range-extending trailer and the vehicle power controller of the electric tow vehicle, wherein the transferred electrical power supplements power available to the electric tow vehicle from the vehicle battery pack.

2. The method of claim 1, wherein the transferring of the electrical power occurs while the electric vehicle-trailer combination is moving.

3. The method of claim 1, wherein transferring the electrical power comprises transferring the electrical power through a trailer coupler-battery interconnect connecting the trailer battery pack with the trailer electric power coupler.

4. The method of claim 3, wherein transferring the electrical power comprises using a bidirectional trailer on-board charger to:
convert direct current power flown from the trailer battery pack into alternating current power flown to the trailer electric power coupler; and
convert alternating current power flown from the trailer electric power coupler into direct current power flown to the trailer battery pack.

5. The method of claim 4, wherein:
the electric tow vehicle comprises a vehicle on-board charger comprising a vehicle inverter; and
the method further comprises converting direct current power flown from the vehicle battery pack into alternating current power flown to the vehicle electric power coupler using the vehicle inverter.

6. The method of claim 1, wherein transferring the electrical power comprises transferring alternating current power between the electric tow vehicle and the range-extending trailer through the vehicle electric power coupler and the trailer electric power coupler.

7. The method of claim 6, wherein transferring the electrical power comprises converting direct current power flown from the trailer battery pack into alternating current power flown to the trailer electric power coupler using a trailer on-board charger comprising a trailer inverter.

8. The method of claim 7, wherein:
the electric tow vehicle comprises a vehicle on-board charger coupled to the vehicle battery pack and the vehicle electric power coupler; and
transferring the electrical power comprises converting alternating current power flown from the vehicle electric power coupler into direct current power flown to the vehicle battery pack using a vehicle on-board charger.

9. The method of claim 8, wherein the trailer battery pack operates at a different voltage than the vehicle battery pack.

10. The method of claim 8, wherein the trailer battery pack operates at a different state of charge than the vehicle battery pack.

11. The method of claim 8, further comprising forming a connection between the trailer on-board charger and an external AC power source using a trailer connector and charging the trailer battery pack using alternating current power from the external AC power source.

12. The method of claim 8, further comprising forming a connection between the vehicle on-board charger and an external AC power source and charging the vehicle battery pack using alternating current power from the external AC power source.

13. The method of claim 1, wherein the control instructions received at the trailer power controller from the electric tow vehicle comprise a power transfer demand from the trailer battery pack.

14. The method of claim 13, wherein determining the power transmission requirement comprises determining the power transfer demand based on one or more of:
a throttle position,
a brake pedal position,
a state of charge of the vehicle battery pack, and
a temperature of the vehicle battery pack.

15. The method of claim 1, wherein controlling the transferring of the electrical power comprises controlling the electrical power based on one or more of:
the control instructions received at the trailer power controller from the electric tow vehicle,
a state of charge of the trailer battery pack, and
a temperature of the trailer battery pack.

16. The method of claim 1, wherein determining the power transmission requirement and transferring the electrical power comprise prioritizing cycling of the trailer battery pack over the cycling of the vehicle battery pack.

17. The method of claim 1, wherein determining the power transmission requirement and transferring the electrical power comprise controlling transfer of electrical power between the electric tow vehicle and the range-extending trailer such that a state of charge of the vehicle battery pack is maintained within a defined state of charge range during operation of the electric vehicle-trailer combination.

18. The method of claim 1, wherein forming the electric power coupling comprises forming the electric power connection using a wireless power transfer interface.

19. The method of claim 1, wherein forming the communication link comprises forming the communication link using a wireless communication protocol.

20. The method of claim 1, wherein:
the electric tow vehicle comprises fluid passages extending through the vehicle battery pack,
the trailer comprises fluid passages extending through the trailer battery pack, and
the method further comprises:
interconnecting the fluid passages of the vehicle battery pack and the trailer battery pack, and
flowing a thermal fluid through interconnected fluid passages of the vehicle battery pack and the trailer battery pack, such that the thermal fluid flows between the vehicle battery pack and the trailer battery pack, thereby allowing one of the vehicle battery pack or the trailer battery pack to function as a heat sink for the other during operation of the electric vehicle-trailer combination.
